(19) United States
(12) Patent Application Publication
(10) Pub. No.: US 2011/0252663 A1
(43) Pub. Date: Oct. 20, 2011

(54) Agricultural material dryer

(75) Inventors: David J. Ralph, Johnston, IA (US); Walter J. Jacobsen, Perry, IA (US)

(73) Assignee: Global Seed Dryer Solutions, LLC

(21) Appl. No.: 12/799,192

(22) Filed: Apr. 19, 2010

(51) Int. Cl. F26B 3/02; F26B 19/00; F26B 25/06

(52) U.S. Cl. 34/493; 34/218; 34/549

(57) ABSTRACT

A double pass reversing dryer provided with a main heat source for heating air passing through the upper plenum and a supplemental heat source for heating air as it passes from the upper plenum to the drying bin. When the double pass reversing dryer of the present invention is in an unbalanced state with more high moisture content agricultural material to be dried than low moisture content agricultural material to be dried, the temperature in the upper plenum is reduced and some of the air is vented directly to the lower plenum. The remainder of the air in the upper plenum is heated by a secondary heat source before the air passes into the drying bin containing the low moisture content agricultural material.

### TECHNICAL FIELD

The present invention relates generally to agricultural material dryers. The present invention relates particularly to agricultural material dryers that evenly dry agricultural material having various moisture contents.

### BACKGROUND

Double-pass reversing dryers are known in the art. Such dryers are provided with two sets of drying bins in two parallel rows. Provided between the rows of parallel bins are an upper plenum and a lower plenum. Each bin is provided with a sloped, raised floor to retain agricultural material, such as corn or the like. The tops of the bins are in fluid communication with the upper plenum and the bottoms of the bins are in communication with the lower plenum.

Gates are provided over the openings between the plenums and the bins to direct the flow of heated air around the grain as desired. The upper plenum is pressurized with heated air provided from one or both ends of the plenum. When the bins are first loaded with agricultural material, the material is at a high moisture content. The upper plenum heated air temperature is set at a lower than maximum temperature and passed through these bins to reduce the risk of damage to the high moisture content agricultural material.

After the process has progressed to the point that one or more bins of agricultural material is sufficiently dry, the upper plenum air temperature is increased and the air is directed through the agricultural material that has already had some moisture removed. As the air moves through the agricultural material, the air loses heat to, and gains moisture from the agricultural material. Thereafter, the cooled, moisturized air leaves the bin and enters the lower plenum. From the lower plenum, the cooled and moisturized air mixes with air in the plenum from other bins and is directed into the lower bin area of drying bins containing higher moisture content agricultural material. As the higher moisture content agricultural material is more sensitive to damage associated with higher temperatures, the agricultural material in these bins is provided with the cooler, more moisturized air until a predetermined moisture content has been reached.

Commonly, the process continues until the agricultural material in the first bin has been dried sufficiently. Thereafter, the dried agricultural material is removed and replaced with new high moisture agriculture material. The flow of the air is then reversed so that the hotter air from the upper plenum is directed first into the bins in which the agricultural material had been partially dried. The warmer, drier air is directed through the agricultural material, out of the bins into the lower plenum and thereafter into and upward through the new high moisture content agricultural material.

This process works well for double-pass, reversing dryers which are balanced, namely those which have an equal amount of bins filled with high moisture content agricultural material and bins filled with low moisture content agricultural material. In the event, however, the new quantity of agricultural material to be dried is greater than or less than the quantity of agriculture material being removed from the double-pass, reversing dryer, the operator must operate the double-pass, reversing dryer at a lower efficiency. In the case of a greater number of bins with new, higher moisture agricultural material to be dried, the operator must pass a portion of the heated air directly from the upper plenum to the lower plenum via doors between the plenums. To avoid damage to the agricultural material due to excessive heat, the operator must reduce the upper plenum heated air temperature, providing less heat to the low moisture content agricultural material in communication with the upper plenum, thereby increasing the drying time. If the amount of new higher moisture content agricultural material to be dried is less than the amount of partially dried agricultural material in the bins, there will be a fewer number of bins with new, higher moisture agricultural material to be dried. This will cause excessive pressure in the lower plenum from the excess heated air passing through the previously dried low moisture content agricultural material and increased airflow through the fewer number of bins with the new higher moisture content agricultural material. The operator must, therefore, vent air from the lower plenum directly into the atmosphere, thereby wasting heat.

An additional drawback of a double-pass, reversing dryer operating in an unbalanced condition is that the pressure differential between the upper plenum and the lower plenum, may cause the different types of agricultural material to dry too slowly or too quickly. It would, therefore, be desirable to provide a system and method for using a double-pass, reversing dryer which allowed for efficient, even drying of agricultural material even when the dryer contained different quantities of high moisture content and low moisture content agricultural material. The difficulties described hereinabove are substantially eliminated by the present invention.

### SUMMARY OF THE DISCLOSED SUBJECT MATTER

This Summary is provided to introduce concepts in a simplified form. The Detailed Description that follows describes these concepts further. This Summary is not designed to detail key or essential features of the claimed subject matter. This Summary is not intended to be used as an aid in determining the scope or the meaning of the claimed subject matter.

A double-pass, reversing dryer is provided with an upper plenum and a lower plenum. Provided along each side of the plenums are drying bins. A heater and an air mover are provided to supply heated air to the upper plenum. A second heater is provided to heat the air as it moves from the upper plenum into the drying bins. Preferably, this second heater is a fluid filled pipe coupled to a heat exchanger.

### BRIEF DESCRIPTION OF THE DRAWINGS

The present invention will now be described, by way of example, with reference to the accompanying drawings in which:

FIG. 1 illustrates a top perspective view of the agricultural material dryer of the present invention;

FIG. 2 illustrates a top perspective view of a heat exchanger of the present invention positioned within the opening of a drying bin with the air control door open;

FIG. 3 illustrates a top plan view in cross-section of the agricultural material dryer of the present invention;

FIG. 4 illustrates a front elevation in cross-section of the agricultural material dryer of FIG. 1;

FIG. 5 illustrates a top plan view in cross-section view of the agricultural material dryer of FIG. 1, shown with the dryer in an unbalanced state; and

FIG. 6 illustrates a front elevation in cross-section of the agricultural material dryer of FIG. 1, shown running in an unbalanced environment.

### DETAILED DESCRIPTION OF THE DRAWINGS

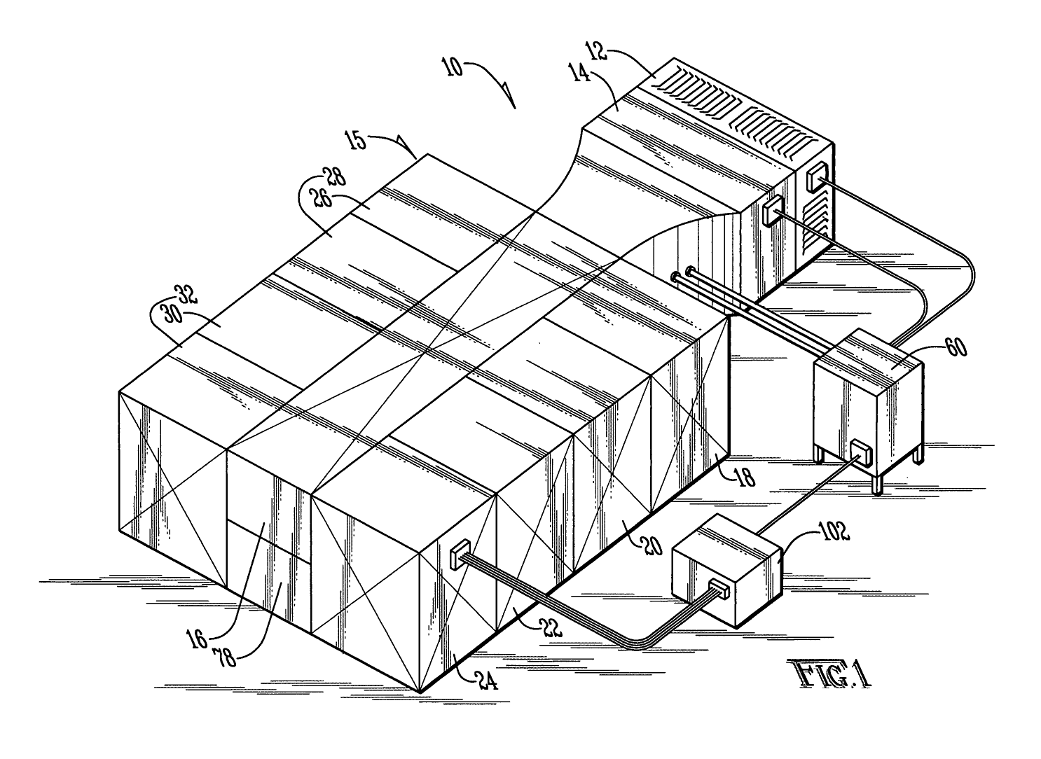

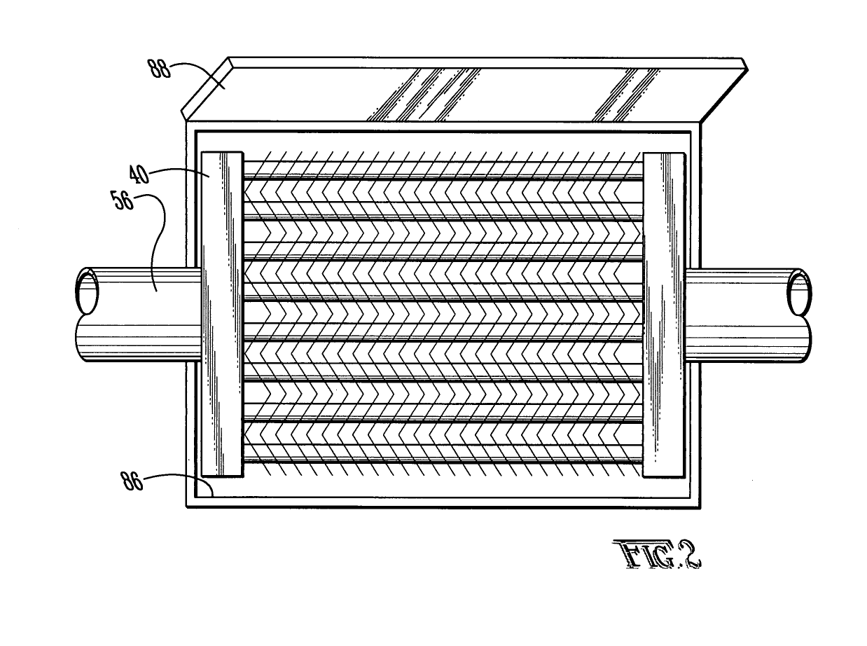

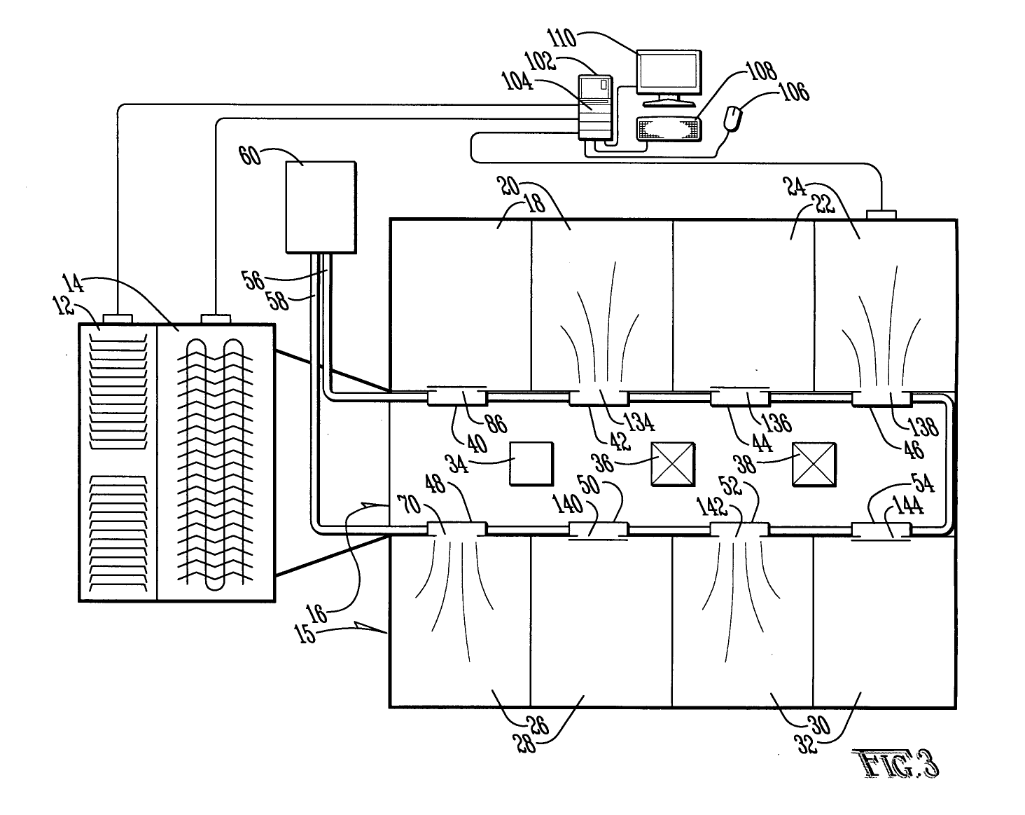

With reference to the drawings, an agricultural material dryer according to the present invention is shown generally as (10) in FIG. 1. The dryer (10) includes an air mover, such as a fan (12), coupled to a heater (14), such as a combustion heater (14). The fan (12) is coupled to a dryer housing (15) defining an upper plenum (16), a lower plenum (78) and a plurality of drying bins (18), (20), (22), (24) (26), (28), (30) and (32). (FIGS. 1, 3 & 5). Provided on the floor of the upper plenum (16) are a plurality of gates which are preferably bypass air control doors (34), (36) and (38). (FIGS. 1-2). The bypass air control doors (34), (36) and (38) may be manually or automatically operated to open and close fluid communication between the upper plenum (16) and lower plenum (78).

Shown in FIG. 3 are a plurality of heaters which are preferably heat exchangers (40), (42), (44), (46), (48), (50), (52) and (54). Alternatively, the heaters may be natural gas, propane or electric heaters, or any other type of heater known in the art. As shown in FIG. 3, the heat exchangers (40) are of a radiator type connected to one another by a fluid filled pipe (56). The pipe (56) is constructed of stainless steel and covered with a fiberglass jacket to reduce heat loss. Alternatively, the pipe (56) may be constructed of polyvinylchloride or any suitable material. The pipe (56) is filled with water (58), air, or other heat exchanging fluid (58), such as those known in the art. The pipe (56) is coupled to a heater, such as a boiler (60), or other type known in the art capable of supplying a desired amount of heat to the water (58).

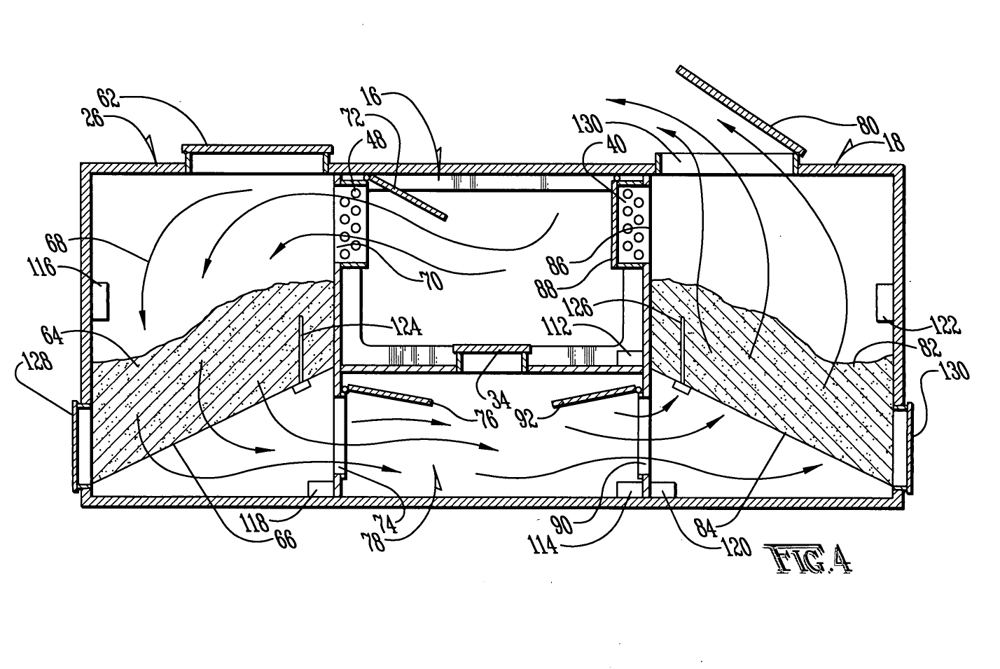

The bin (26) is provided with an exhaust door (62) that also serves as a loading door through which, as shown, the low moisture content agricultural material (64) is provided. The drying bin (26), as shown in FIG. 4, was previously loaded with high moisture content agricultural material prior to the last drying cycle. The drying bin (26) is also provided with an upper opening (70) to the upper plenum (16), which is covered by an air control door (72). The drying bin (26) is provided with a lower opening (74) covered by another air control door (76). The lower opening (74) opens into a lower plenum (78), located directly below the upper plenum (16). On the opposite side of the plenums (16) and (78) from the drying bin (26) is the drying bin (18). The drying bin (18) is also provided with an exhaust door (80), and is filled with high moisture content agricultural material (82). The drying bin (18) is provided with a raised and slanted floor (84), as well as an opening (86) into the upper plenum (16) covered by an air control door (88). The drying bin (18) also has an opening (90) into the lower plenum (78) covered by the air control door (92). All of the air control doors may be manually or automatically operated agricultural material dryer doors such as those known in the art.

By means of the air control doors, each individual bin (26) can be configured to operate at least three modes regarding airflow through the agricultural material (64) in the bin (26). The first mode is to have no airflow, with both air control doors (72) and (76) closed. In this configuration the bin (26) is referred to as being “Off” with regard to airflow. The second mode is to have air from the upper plenum (16) flowing through the open upper plenum control door (72), through the agricultural material (64) in the bin (26) and into the lower plenum (78) via the open lower plenum air control door (76). In this configuration the bin (26) is referred to as being “On Down Air” with regard to airflow. The third mode is to have air from the lower plenum (78) flowing through the open lower plenum air control door (76) through the agricultural material (64) and into the atmosphere via the exhaust door (62). The upper plenum air control door (72) is closed. In this configuration the bin (26) is referred to as being “On Up Air” with regard to airflow.

As shown in FIGS. 3-4, the fan (12), heater (14), air control doors (72), (76), (88) and (92), the exhaust doors (62) and (80), bypass air controllers (34), (36) and (38), and boiler (60) are all coupled to, and controlled by, a master controller (102). Alternatively, the dryer (10) may be manually operated by a human operator (not shown). The master controller (102) is a computer having a central processing unit (104), an input device, such as a mouse (106), or keyboard (108), and a display (110). The master controller (102) is also preferably coupled to a plurality of temperature gauges (112), (114), (116), (118), (120) and (122), provided within the upper plenum (16), lower plenum (78) and drying bins (18) and (26). The temperature gauges (112), (114), (116), (118), (120) and (122) are positioned above and below the floors (66) and (84), in each of the drying bins (18) and (26) to determine the temperature of the air (68) before and after it has passed through the agricultural material (64) and (82).

The master controller (102) may be coupled to grain moisture probes (124) and (126) provided within the drying bins (18) and (26) to determine the moisture content of the agricultural material (64) and (82) within the drying bins (18) and (26). The master controller (102) may be programmed, depending upon the moisture content of the agricultural material (64) and (82), the ambient temperature, and other factors, to automatically adjust the operation of the agricultural material dryer (10).

Preferably, the drying bins (18), (20), (22), (24), (26), (28), (30) and (32) are operated in an opposing and staggered pattern. As shown in FIG. 3, the previously dried low moisture content agricultural material (82) is provided in drying bins (18), (22), (28) and (32). High moisture content agricultural material is provided in drying bins (20), (24), (26) and (30). The opposing and staggered distribution of low moisture and high moisture agricultural material facilitates more even distribution of heat and moisture in the plenums (16) and (78). Alternatively, the distribution of agricultural material may be in any desired configuration.

After the agricultural material in the drying bin (18) has been sufficiently dried, the unloading door (128) is opened and the agricultural material removed. Thereafter, the exhaust door (80) is opened and a new quantity of high moisture content agricultural material (82) is inserted into the bin (18). Preferably, the agricultural material (82) is provided on the floor (84) to a depth of approximately 2.5 meters.

As shown in FIGS. 3-4, the agricultural material (64) in the drying bin (26) has already been through approximately half of the drying process and a predetermined percentage of moisture in the material (64) has been removed. The master controller (102) is thereafter operated or previously programmed to actuate the fan (12) and heater (14) to drive air (68) into the upper plenum (16). The master controller (102) adjusts the heater (14) to heat the air (68) to a predetermined temperature. In the case of corn this predetermined temperature is typically between 110°-115° Fahrenheit. This is a typical upper plenum temperature.

The master controller (102) opens the air control door (72) to allow the heated air (68) into the drying bin (26). The heated air passes through the agricultural material (64). Typically, about fifty percent of the air pressure is lost as the air passes through the agricultural material (82). As the air moves through the agricultural material (82), the air typically loses eight to twelve degrees Fahrenheit as it gains moisture. The master controller (102) opens the air control door (76) to allow the air (68) to exhaust into the lower plenum (78). The master controller (102) opens the air control door (92) to allow the air (68) to pass into the drying bin (18) and pass upward through the high moisture content agricultural material (82).

Because the air (68) has already been cooled and moisturized by the low moisture content agricultural material (64), the air (68) is less prone to damage the high moisture content agricultural material (82) provided in the drying bin (18). After the air (68) has passed through the high moisture content agricultural material (82), the air (68) passes upward through the exhaust (130) once the exhaust door (80) has been opened by the master controller (102). The process continues until the low moisture content agricultural material (64) has reached a desired moisture content.

The unloading door (128) is then opened to remove the agricultural material (64). High moisture content agricultural material is then added to the drying bin (26) through the exhaust door (62) and the master controller (102) reverses the process, opening the air control door (88) in the upper plenum (16) to the drying bin (18), closing the exhaust door (80), closing the air control door (72) and opening the exhaust door (62) to allow the warm air to pass through the agricultural material (82) in the drying bin (18) through the lower plenum (78), upward through the agricultural material (64) in the drying bin (26) and out past the exhaust door (62).

The upper plenum (16) can be supplied with a typical upper plenum temperature as long as the dryer (10) is balanced. This will result in a typical lower plenum temperature. When the combined number of On Up Air and Down Air bins in the dryer (10) is such that the dryer (10) cannot be balanced, or when ambient temperature or moisture content dictates drying conditions which cannot be achieved by the foregoing process, the master controller (102) may actuate one or more of the air control doors (34), (36) and (38) in combination with the boiler (60) to heat and move the water (58) through the fluid filled pipe (56) and through the heat exchanger(s) (40), (42), (44), (46), (48), (50), (52) and (54) located in the upper doors of the bins.

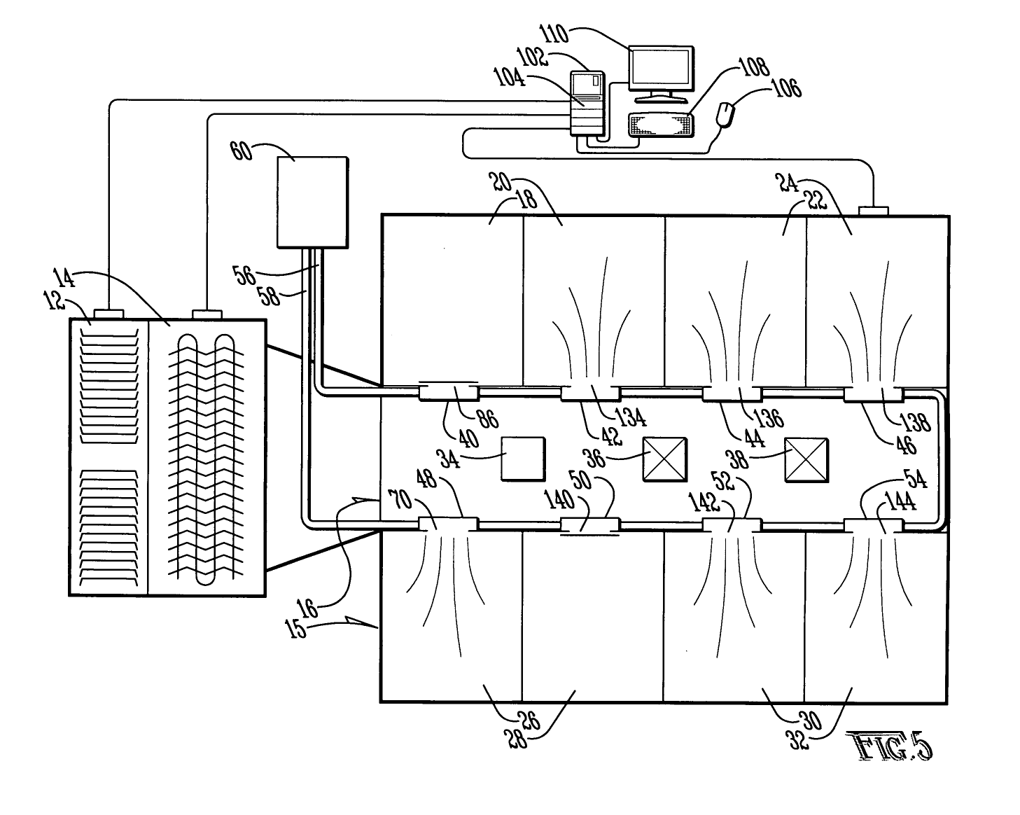

Shown in FIG. 5 is a situation where the operator is faced with less low moisture content agricultural material (64) than high moisture content agricultural material (82). This may lead to a situation where more bins (20), (22), (24), (28), (30) and (32) are filled with high moisture content agricultural material (82) than bins (18) and (26) containing low moisture content agricultural material (64). As the result, the agricultural material dryer (10) will have increased pressure in the upper plenum (16) and lower pressure in the lower plenum (78). This will cause the low moisture content agricultural material (64) to dry too quickly and the high moisture content agricultural material (82) to dry too slowly.

In prior art systems the air control doors (36) and (38) may be opened somewhat to decrease the pressure in the upper plenum (16) and increase the pressure in the lower plenum (78). However, since the air (68) in the upper plenum (16) ma potentially be heated to a temperature fifteen to twenty-five degrees greater than the temperature of air in the lower plenum (78), this temperature differential may cause damage to the higher moisture content agricultural material (82). Therefore, only a limited amount of heated air (68) in the upper plenum (16) may safely be bypassed to the lower plenum (78). To prevent the low moisture content agricultural material (64) from being damaged, the overall temperature and/or pressure of the air (68) in the upper plenum (16) must be reduced by decreasing the output temperature and/or pressure of the fan (12), thereby decreasing the overall efficiency of the agricultural material dryer (10).

When an unbalanced drying situation occurs as shown in FIG. 5, the master controller (102) actuates the boiler (60) to heat and push the water (58) through the fluid filled pipe (56). The fluid filled pipe (56) is preferably coupled to the plurality of heat exchangers (40), (42), (44) (46), (48), (50), (52) and (54) provided over the openings (70), (86), (134), (136), (138), (140), (142) and (144) to the drying bins (18), (20), (22), (24), (26), (28), (30) and (32).

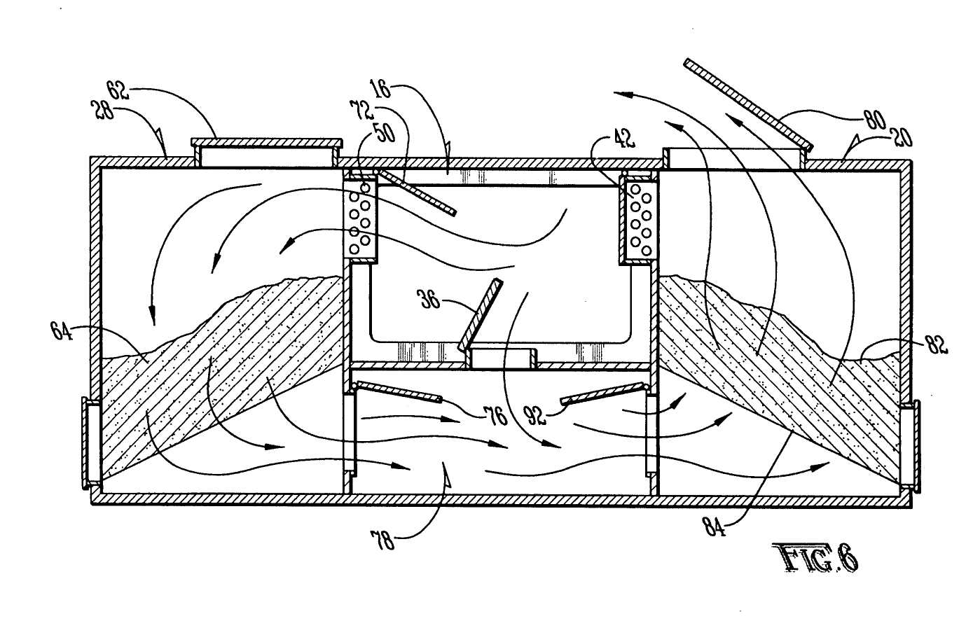

In the balanced system described above, and in FIGS. 1-4, the temperature in the upper plenum (16) is approximately the optimal temperature for drying the low moisture content agricultural material (64), such as 110°-115° Fahrenheit for corn, and the temperature of the air (68) in the lower plenum (78) is approximately the optimal temperature for drying the high moisture content agricultural material (82), such as 90°-95° Fahrenheit for corn. When the system is unbalanced as shown in FIGS. 5 and 6, where fewer of the drying bins (18) and (28) contain low moisture content agricultural (64) than bins (20), (22), (24), (26), (30) and (32) that contain high moisture content agricultural material (82), the air pressure in the upper plenum (16) is greater than the air pressure in the lower plenum (78) as the air (68) exiting the upper plenum (16) must pass through a smaller area than air (68) exiting the lower plenum (78). If the bypass air control doors (34), (36) and (38) were simply opened to place the upper plenum (16) in fluid communication with the lower plenum (78), the air temperature in the lower plenum (78) would be too great, thereby risking damage to the high moisture content agricultural material (82) as the result of overly fast or excessive heat drying conditions.

To avoid damage to the high moisture content agricultural material (82) while maintaining the desired pressure differential between the upper plenum (16) and lower plenum (78), a predetermined number of bypass air control doors (36) and (38) are opened by the master controller (102) a sufficient amount to provide the desired pressure differential between air (68) in the upper plenum (16) and lower plenum (78). To reduce damage to the high moisture content agricultural material (82), the master controller (102) attenuates the heater (14) so that the optimal temperature in the upper plenum (16) is approximately equal to the optimal desired temperature for air (68) in the lower plenum (78). While this configuration reduces the pressure differential between the upper plenum (16) and lower plenum (78), and reduces damage to the high moisture content agricultural material (82) associated with overly fast drying, the configuration supplies the low moisture content agricultural material (64) with a temperature of air (68) below the optimal drying temperature, thereby increasing the time associated with drying the low moisture material (64).

The master controller (102), therefore, actuates the boiler (60) to supply heated water (58) through the fluid filled pipe (56). The water (58) passes through the heat exchangers (40), (42), (44), (46), (48), (50) and (52). As the air (68) only passes from the upper plenum (16) to drying bins (18) and (28) through two openings (86) and (140), the master controller (102) regulates the boiler (60) to supply a sufficient amount of heat to the water (58) to heat the air (68) passing in proximity to the heat exchangers (40) and (50) to the optimal desired temperature for drying the low moisture content agricultural material (64). The heat exchangers (40), (42), (44), (46), (48), (50) and (52) may each be provided with separate controls, coupled to the master controller (102), to increase or decrease the amount of heat dissipated by each heat exchanger relative to one another.

Once the air (68) heated by the heat exchangers (40) and (50) passes through the low moisture content agricultural material (64), the air enters the lower plenum (78) at about the desired optimal temperature for drying the high moisture content agricultural material (82). This air (68) mixes with air passing directly from the upper plenum (16) to the lower plenum (78) through the bypass air control doors (36) and (38) to, thereafter, pass upward through the high moisture content agricultural material (82) contained within the drying bins (20), (22), (24), (26), (30) and (32). This drying process continues until the low moisture content agricultural material (64) has been sufficiently dried and the high moisture content agricultural material (82) has been dried to the point where it can be treated as low moisture content agricultural material (64) for additional drying.

Although the invention has been described with respect to a preferred embodiment thereof, it is to be understood that it is not to be so limited since changes and modifications can be made therein which are within the full, intended scope of this invention as defined by the appended claims. As an example, any number of drying bins and any number of fans, heaters, plenums and heat pumps may be used. The heater and fan may also be used to supply heated air directly to the lower plenum.

What is claimed is:

1. An agricultural material dryer comprising:
(a) an air mover;
(b) a first structure defining a first plenum coupled to the air mover;
(c) a first heater for increasing the temperature of air in the first plenum to a first predetermined temperature;
(d) a second structure defining a second plenum;
(e) a first drying bin defining a first opening to the first plenum and a second opening to the second plenum;
(f) a second heater for increasing the temperature of air passing from the first plenum to the first drying bin from the first predetermined temperature to a second predetermined temperature; and
(g) a second drying bin defining a third opening to second plenum.

2. The agricultural material dryer of claim 1, further comprising a third drying bin provided adjacent the first drying bin.

3. The agricultural material dryer of claim 2, further comprising a third heater for increasing the temperature of air passing from the first plenum to the third drying bin from the first predetermined temperature to a third predetermined temperature.

4. The agricultural material dryer of claim 3, the second predetermined temperature and the third predetermined temperature are the same.

5. The agricultural material dryer of claim 2, further comprising a fourth drying bin defining a fourth opening to the second plenum.

6. The agricultural material dryer of claim 1, the second heater is a fluid filled pipe.

7. The agricultural material dryer of claim 4, the first heater is a combustion heater.

8. The agricultural material dryer of claim 1, the first plenum is provided above the second plenum.

9. The agricultural material dryer of claim 8, the first drying bin is provided adjacent the first plenum and the second plenum.

10. The agricultural material dryer of claim 1, the second heater is a heat exchanger coupled to a heat pump.

11. An agricultural material dryer comprising:
(a) a dryer housing comprising:
(b) a first drying bin defining a first opening to the first plenum and a second opening to the second plenum;
(c) a first raised, slanted floor positioned within the first drying bin;
(d) a second drying bin defining a third opening to the second plenum;
(e) a second raised, slanted floor positioned within the second drying bin;
(f) a first heater;
(g) a fan configured to blow heat from the first heater into the first plenum;
(h) a fluid filled pipe provided within the dryer housing; and
(i) a second heater coupled to the fluid filled pipe.

12. The agricultural material dryer of claim 11, further comprising a gate provided between the first plenum and the second plenum.

13. The agricultural material dryer of claim 11, further comprising a gate provided between the first plenum and the second plenum.

14. The agricultural material dryer of claim 11, wherein the fluid filled pipe is located within the first plenum.

15. The agricultural material dryer of claim 11, wherein the fluid filled pipe is located adjacent the first opening.

16. A method of drying agricultural material comprising:
(a) providing an agricultural material dryer comprising:
(i) an air mover;
(ii) a first structure defining a first plenum coupled to the air mover;
(iii) a first heater;
(iv) a second heater;
(v) a second structure defining a second plenum;
(vi) a first drying bin defining a first opening to the first plenum and a second opening to the second plenum;
(vii) a second drying bin defining a third opening to the second plenum;
(b) providing a first quantity of agricultural material in the first drying bin and providing a second quantity of agricultural material in the second drying bin;
(c) heating air with the first heater to produce heated air;
(d) moving the heated air through the first plenum with the air mover;
(e) passing the heated air from the first plenum into the first drying bin;
(f) heating the heated air within the first drying bin and above the first quantity of agricultural material to a greater average temperature than the average temperature of the heated air within the first plenum;
(g) passing the heated air across the first quantity of agricultural material in the first drying bin to produce cooled air;
(h) passing the cooled air from the first drying bin into the second plenum;
(i) passing the cooled air from the second plenum to the second drying bin; and
(j) passing the cooled air across the second quantity of agricultural material in the second drying bin.

17. The method of drying agricultural material of claim 16, the second heater is a boiler coupled to a heat pump.

18. The method of drying agricultural material of claim 17, further comprising a first plurality of drying bins provided adjacent the first drying bin and a second plurality of drying bins provided adjacent the second drying bin.

19. The method of drying agricultural material of claim 16, further comprising providing a gate between the first plenum and the second plenum and passing heated air from the first plenum to the second plenum across the gate.

20. The method of drying agricultural material of claim 16, further comprising providing a first raised, slanted floor within the first drying bin and a second raised, slanted floor within the second drying bin.
